(19) United States
(12) Patent Application Publication
(10) Pub. No.: US 2001/0004589 A1
(43) Pub. Date: Jun. 21, 2001

(54) Calling method for mobile telephones and a server and a radiocommunications terminal for implementing the method

(76) Inventors: Christian Massy, Sevres (FR); Alain Guirauton, Argenteuil (FR)

Correspondence Address: SUGHRUE, MION, ZINN, MACPEAK & SEAS, PLLC, 2100 Pennsylvania Avenue, N.W., Suite 800, Washington, DC, 20037-3213, US

(21) Appl. No.: 09/736,200

(22) Filed: Dec. 15, 2000

(30) Foreign Application Priority Data
Dec. 16, 1999 (FR) 99 15 867

(51) Int. Cl. H04M 3/42

(52) U.S. Cl. 455/414; 455/563; 455/564

(57) ABSTRACT

A distributed intelligence speech recognition system is used to solve a problem of recognizing names of parties spoken by users into a mobile telephone. A very powerful speech recognition server available to a collective of users in the switching services area of a mobile telephone carrier performs said recognition or part of said recognition. The speech recognition calls are transmitted in GPRS mode to reduce the traffic time between the mobile telephone and the server.

The present invention relates to a calling method for mobile telephones and to a mobile telephone and a server that can be used to implement the method. The invention is more particularly intended to recognize the spoken name of a called party or a spoken command and automatically dial a telephone number corresponding to the name of a recognized called party or execute the action associated with the command.

### BACKGROUND OF THE INVENTION

In the field of mobile telephones, and in particular in the field of GSM (Global System for Mobile communications) mobile telephones, because speech signals are digitized by vocoders (CODECs), consideration was given at a very early stage to employing means already available in mobile telephones to dial called numbers automatically. In theory, a user presses a special key on the keypad of their mobile telephone at the same time as they speak the name of a party they want to call. After the key is released, or after a time-delay, a microprocessor in the mobile telephone executes a speech recognition program which establishes the correspondence between a bit stream representing a digitized speech signal and an expected bit stream representing the name of a person to be called. Then, using the recognized bit stream as an address, the microprocessor looks up a telephone number corresponding to the person to be called in a directory table. Finally, the mobile telephone dials the corresponding number automatically. However, a procedure of the above kind is not efficient in practice because the mobile telephone cannot produce an expected bit stream corresponding to a number contained in its memory or it recognizes one that is not the correct one. The reason for these shortcomings is to be found in the recognition algorithm used by the recognition program. Because of its simplicity, and available energy limitations, a mobile telephone microprocessor can execute only a simplified speech recognition algorithm.

Given this problem, consideration has been given to sharing the speech recognition task between the mobile telephone and a speech recognition server which can be accessed by the mobile telephone. Where appropriate, all speech recognition tasks can be handled by a server. For example, U.S. Pat. No. 5,297,183 discloses a distributed architecture with which a very powerful and very fast processor in the server can produce a recognition signal that is much more accurate and can be used or interpreted better by the mobile telephone. A distributed speech recognition (DSR) standard is currently at the discussion stage and covers some aspects of speech recognition: speech coding type, type of distribution of recognition functions effected both by the mobile telephone and by the recognition server, formatting of data produced or to be recognized, and so on. Furthermore, the cited document refers to the necessity for recognition to be speaker-dependent, on the one hand, and speaker-independent, on the other hand. Developments in this field lead to a highly acceptable recognition result.

There is nevertheless still a problem. The call between the mobile telephone and the server takes too long. It has been estimated that the above recognition method requires a time period substantially equal to ten seconds, or even more. That is too long. Moreover, above and beyond the waiting time for the caller, there is a price disadvantage associated with the time for which a radio channel is used. The cost of automatic dialing with a system of the above kind is of the same order as the cost of a local call on a switched telephone network. That cost is excessive and is impeding general adoption of this method.

### OBJECTS AND SUMMARY OF THE INVENTION

The inventors have realized that the excessively long time needed to make the recognized name available is essentially related to the line seizure method used in mobile telephony, in particular in GSM mobile telephony. Thus to solve this problem, rather than using a conventional private connection mode, which is a circuit mode, for the mobile telephone to recognition server connection, the invention uses a packet transmission mode, preferably a connectionless packet transmission mode. Briefly, a GSM connection protocol has two parts: setting up a circuit and transferring traffic on a circuit once it has been set up. Once a circuit has been set up, users have a maximum bit rate that they can choose to use or not to use. Payment for the service is conditioned by the duration for which the circuit is made available. This means in particular that users pay even if they or the other party do not speak at their respective ends of a line.

Broadly speaking, in a packet transmission mode, no preferential circuit is set up between a caller and the server (and between the called party and the server). To the contrary, a caller produces information packets each of which is associated with the address of the called party, which is its destination. The overall usable information bit rate is reduced because of the presence of the address in the packet transmitted, generally accompanied by a packet number. However, this method of transmission is more advantageous in the sense that billing is more realistic in that it corresponds exactly to usage of the transmission media, in proportion to the packets transmitted. In this case, users pay only for the packets transmitted. They pay nothing if they transmit nothing, even if they remain connected. This opens up the possibility for the mobile telephone to be connected all the time, at zero cost, avoiding the time wasted on line seizure.

The idea of the invention is therefore to use a packet transmission mode, preferably a connectionless packet transmission mode, for complete recognition of a called party name or a command to be transmitted between the mobile telephone and the server, in the uplink and/or downlink direction, and preferably in both directions. In the GSM field in particular, packets can be transmitted in accordance with the GPRS data transport standard. In this case, for transmission, i.e. in the outgoing direction from the mobile telephone, the number of packets can be small, because speaking a name takes approximately one second, corresponding to about fifty packets. In return, the server transmits a recognition signal which can also be compressed, possibly into a single packet addressed to the calling mobile telephone.

Thus the invention not only reduces the effective duration of media use but also connects the mobile telephone to the server and the server to the mobile telephone faster. There is no latency time in setting up a circuit between a mobile telephone and the server, and vice versa, because a packet-oriented broadcast mode is used, instead of a private communications mode involving setting up a circuit. It will be shown that in this case, in accordance with the invention, the telephone number to be dialed can be determined in less than two seconds from the end of speaking the name of the called party, and even then without all of that two-second period being billed as transmission time.

The invention therefore consists in a calling method for mobile telephones, wherein:

speech information representing the name of a party to be called or a command to be executed, for example, is spoken into an acoustic sensor of a mobile telephone,

a first digitized speech signal corresponding to said speech information is transmitted to a server,

the server contributes to recognition of said speech information and produces a first recognition signal,

the server transmits said recognition signal to the mobile telephone, and

the mobile telephone interprets the first recognition signal and correspondingly dials a telephone number corresponding to the party to be called or executes the command to be executed,

and in which method the first digitized speech signal or the first recognition signal is transmitted in a packet transmission mode.

The invention also consists in a mobile telephone including an acoustic sensor into which speech information representing the name of a party to be called or a command to be executed, for example, is spoken, means for transmitting to a server a first digitized speech signal corresponding to said speech information, means for interpreting a first recognition signal produced in return by said server and corresponding to said first digitized speech signal, means for automatically dialing a telephone number corresponding to a party to be called or for executing a command to be executed, and means for transmitting the first digitized speech signal in a packet transmission mode.

The invention finally consists in a server provided with means for receiving a first digitized speech signal, for recognizing speech information in corresponding relationship to said first digitized speech signal, producing a first recognition signal, and transmitting said first recognition signal to a mobile telephone, the server including means for transmitting said first recognition signal to the mobile telephone in a packet transmission mode.

### BRIEF DESCRIPTION OF THE DRAWINGS

The invention will be better understood on reading the following description and examining the accompanying drawings. The drawings are provided by way of illustrative example only and are in no way limiting on the invention. In the figures:

FIG. 1 is a diagram showing a system including a mobile telephone and a server that can be used to implement the method according to the invention,

FIG. 2 is a diagram showing the steps of the method according to the invention,

FIG. 3 summarizes the steps of setting up a circuit in conventional mobile telephony, the set-up time being unacceptable, and

FIG. 4 shows an improvement to the method of the invention.

### MORE DETAILED DESCRIPTION

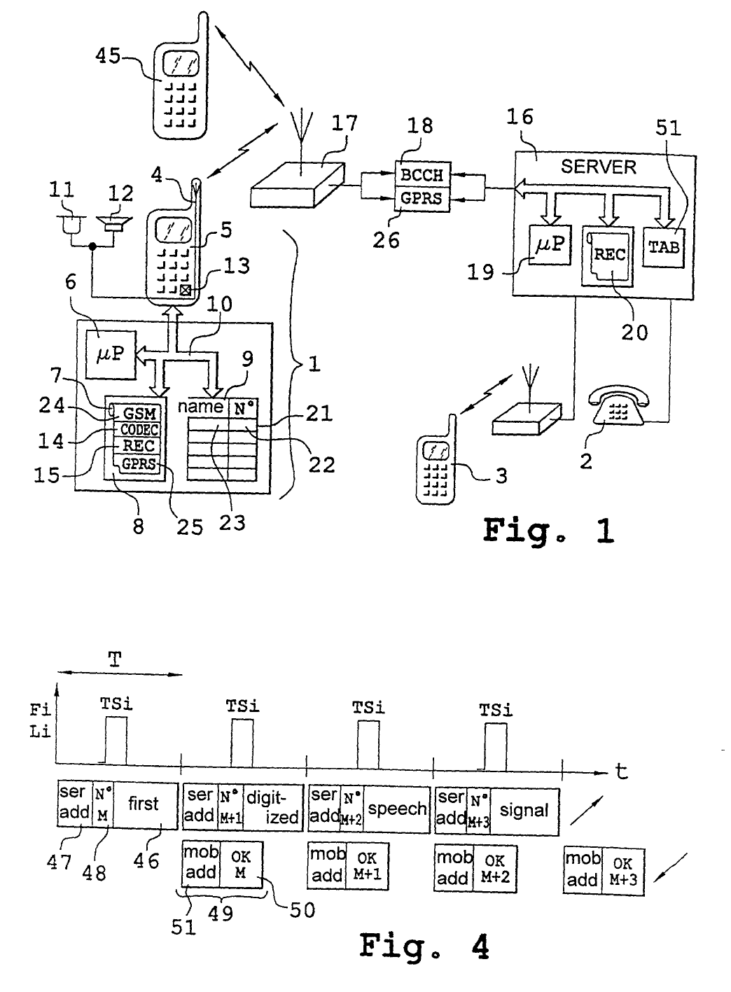

FIG. 1 shows a system that can be used to implement the method of the invention. The system includes a mobile telephone 1 which can be used to call another party who uses a landline telephone 2 or another mobile telephone 3, for example. The mobile telephone 1 conventionally includes a radio system 4 (symbolized by an antenna) and a casing 5 conventionally provided with a screen and a keypad. The radio system 4 is controlled by a microprocessor 6 which executes a program 7 contained in a program memory 8. A data memory 9 is connected by a bus 10 to the microprocessor 6, to the memory 8 and to all of the units of the casing 5. The radio and speech systems include acoustic means symbolized by a microphone 11 and a loudspeaker 12.

As already stated, speaking the name of a party to be called into the acoustic sensor of the microphone 11 is known in the art. This conventionally entails first or simultaneously pressing a special key 13 (or a combination of keys) of the keypad on the casing 5. The program 7 includes a CODEC sub-routine 14 for digitally coding speech picked up by the microphone 11. The speech coding can be handled by the microprocessor 6 (or by a dedicated microprocessor) in conjunction with a speech recognition sub-routine REC 15. In this way the mobile telephone produces a first digitized speech signal. This level of recognition is insufficient and is complemented by more powerful recognition by a speech recognition server 16.

The mobile telephone is connected to the server 16 via a base transceiver station including radio transceiver circuits 17 and BCCH circuits 18 for controlling and monitoring the circuits 17. Pressing the key 13 calls the server 16, which includes a very powerful processor 19 which can execute a very powerful speech recognition program 20, which is of the type described in the document cited above, for example. The program 20 returns to the mobile telephone 1 a first recognition signal corresponding to the digitized speech signal.

The first recognition signal is interpreted in the mobile telephone 1. A complementary recognition operation corresponding to the speaker is performed at this time, for example. The program 15 primarily performs an interpretation, i.e. it fetches from a memory 9 a telephone number present in an area 20 of a record 21 in the memory 9 in corresponding relationship to an area 22 which corresponds to the interpreted recognition signal. The mobile telephone 1 then executes a program 24 (denoted GSM in the diagram) with the telephone number fetched from the area 21, seizes the line and dials the number fetched from the area 21 to call a partly accessible via the landline telephone 2 or the mobile telephone 3.

The foregoing description and the subsequent description refer to a call to a called party. It is nevertheless possible, instead of speaking the name of a called party, to speak a command, for example the command “DIVERT CALLS” to divert all calls to the mobile telephone to another number agreed in advance. In this case, instead of a number being dialed automatically, a command is executed, in this instance the call diversion command. The command is recognized partly by the mobile telephone and partly by the server. In this case, the command recognized by the server need not be returned to the mobile telephone, and can be executed directly by the server. It is preferable for at least an acknowledgment or an acquittal to be sent back to the mobile telephone, however.

The mobile telephone preferably has the option, if the server sends it a recognized command, to accept or refuse execution of the command. For example, the message “DIVERT CALLS?” could appear on the screen of the mobile telephone. The user presses a key on the keypad to confirm the command and to have it executed (by the mobile telephone or the server, depending on the nature of the command). If the server is involved in its execution, there is a third sending of data from the mobile telephone to the server. That third sending of data is an acquittal, for example, which is either positive or negative, according to what the user requires, and is itself also preferably sent in the form of packets.

According to an essential feature of the invention, all of the steps described above which relate to the traffic between the server 16 and the mobile telephone 1 are effected in the uplink direction using a packet transmission sub-routine 25 and in the downlink direction using packet transmission means 26. The GPRS sub-routine 25 is stored in the memory 8. The means 26 are circuits in the control circuits 18 of the base transceiver station. They can also be in part in the server 16. The packet transmission mode adopted is preferably a GPRS (GSM packet radio system) mode. Thus, in accordance with the invention, a step 27 for speaking the name of a called party is followed by a step 28 for sending the first digitized speech signal to the server 16 in packet mode (see FIG. 2). To this end the sub-routine 25 formats the first digitized speech signal into packets.

The base transceiver station receives the first digitized speech signal. Its circuits 26 decode the address of the server 16 contained in the packets it has received and sends the corresponding digitized speech signal to the server 16 in step 30. The server 16 receives the first digitized speech signal in step 31. The processor 19 of the server 16 executes the speech recognition program 20 in step 32. The duration of this operation can be very short. With a very powerful microprocessor 19 it can take about 1 millisecond. The server 16 can therefore be used for multiple callers.

The server 16 produces a first recognition signal in step 33 and, in the case of calls, sends the first recognition signal to the base transceiver station in step 34. The base transceiver station receives the first recognition signal from the server 16 in step 35 and transmits it to the mobile telephone 1 in step 36 in a packet transmission mode, preferably a GPRS mode, and using the circuits 26. The first recognition signal is received in step 37 and interpreted in step 38. Finally, the calling number corresponding to the party to be called is dialed in step 39. In the case of a command rather than a call, return of the recognition signal can be omitted.

The special features of the invention therefore reside in the use of the program 25 and in the use, in the BCCH circuits 18, of the GPRS circuits 26 for packet mode transmission, in particular for transmission in accordance with the GPRS standard.

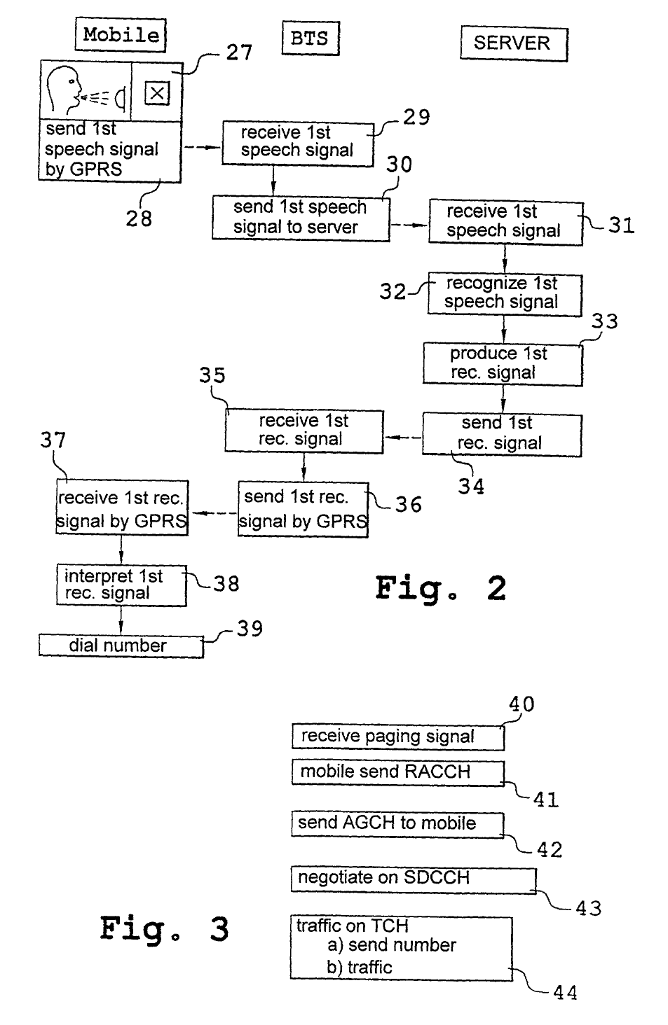

FIG. 3 shows the dialing of the called number corresponding to step 39. It highlights the slowness and the cost of the circuits set up in prior art mobile telephone systems, on the one hand, and the comparative speed and reduced cost of the invention, on the other hand. In one circuit connection mode, a called mobile telephone which is on standby receives a paging signal in step 40. The base transceiver station uses the paging signal to tell the mobile telephone that it is being called. The mobile telephone 1 may be switched off, in which case it naturally does not send back any response signal. If the mobile telephone 1 is available and on standby, it sends a signal RACCH to the base transceiver station in step 41 to report that it is accessible and wishes to be connected to the network to receive the call. In the case of an incoming call step 40 is the first step. In the case of an outgoing call step 41 is the first step. Steps 40 and 41 use a BCCH channel of the base transceiver station.

The base transceiver station then receives the request for connection to the network in step 41 and transmits references of a negotiation channel to the mobile in step 42. The negotiation channel is not the traffic channel. It is a temporary channel on which, in step 43, the base transceiver station and the mobile telephones negotiate all the constraints affecting transmission and the definition of a traffic channel: frequency law, synchronization, power, time slot, transmissible bit rate, and so on. When the negotiation step 43 is finished, the traffic can be established in step 44. In the event of a call, it is only in step 44 that the mobile telephone sends firstly the called number and secondly traffic on a traffic channel TCH. In the prior art, speech recognition has not begun at the start of step 44, the first party called by pressing the button 13 being the server 16.

In the prior art, for the mobile telephone 1 to be able to connect to the server 16, because it is the server that performs the recognition, steps 41 to 43 were necessary. The disadvantage of the call effected by steps 41 to 43 is that it is slow and is billed to the user. In contrast, in GPRS mode, and more generally in packet mode, steps 41 to 43 or their equivalent are executed once and for all when the telephone is activated, for example when users switch on their mobile telephone in the morning.

In GPRS packet mode, however, the channel allocated is not a dedicated channel between the mobile telephone 1 and the base transceiver station 17 which can be used only in circuit mode. To the contrary, it is a channel shared by the mobile telephone 1 and other mobile telephones also communicating with the base transceiver station 17, e.g. the mobile telephone 45. Consequently, steps 41 to 43 are not needed when the special key 13 is pressed.

FIG. 4 is a diagram showing the characteristics of packet mode transmission, for example GPRS packet mode transmission. Mobile telephones on standby are continuously advised of the existence of a GPRS broadcast channel which is characterized in particular by a frequency law Li, an instantaneous carrier frequency Fi and user time slots TSi in the event of time division multiple access (TDMA) operation. The GPRS or packet mode of the invention could nevertheless be feasible in code division multiple access (CDMA) applications. From this point of view the special feature of the invention is that the broadcast channel on which the packets are distributed between the base transceiver station 17 and the various mobile telephones 1 and 45, similar to step 43, is negotiated constantly or regularly updated. The mobile telephones are all advised of it continuously. In this case the mobile telephones 1 or 45 have to receive all of the packets transmitted and decode them all in order extract the ones which are relevant to them. They mark those which are relevant to them by extracting an address from these packets which corresponds to an IMSI number of their subscription, for example. To reduce the power consumption of the mobile telephone 1, it is nevertheless possible for these addresses to be decoded only during a period following pressing of the key 13.

The above considerations lead to a distinction between a connected packet transmission mode and a connectionless packet transmission mode. As a general rule, in a connected packet transmission mode the mobile telephones are connected in the sense that they monitor the network continuously and transmit on the network at random, as and when required. In a connectionless packet transmission mode, the packet broadcast channel is shared, and anti-collision protocols organize the flow between a base transceiver station and the various mobile telephones. In a connected packet transmission mode, there is a hierarchy of rights. The mobile telephone which has chosen the connected option has its requirements dealt with before those of other mobile telephones. The other mobile telephones can use the packet broadcast channel only if that channel is not fully occupied by the mobile telephone that has chosen the connected option. The cost of the connected option is higher, because of this priority: it can be related to the time for which the broadcast channel is reserved in this way. With the connected option, there are also steps prior to channel reservation. The reservation steps are similar to step 43, but shorter. According to the invention, the transmission mode is then preferably a connectionless packet transmission mode (and therefore one without reservation and without priority). On the other hand, in setting up a dedicated circuit at the time of a call, the designation of the traffic channel TCH (which requires similar indications Fi, Li, TSi) is defined in step 43.

FIG. 4 shows the transmission of the first digitized speech signal from the mobile telephone 1 to the base transceiver station 17 in the form of packets. Each packet is diagrammatically represented as sent during a time slot TSi of rank i in a frame T made up of n slots (in the preferred mode n equals 8). Each packet includes an information area 46 containing an address area 47 which in this example designates the server 16. Because the messages are addressed to the server 16, and more precisely to the microprocessor 19 for executing the program 20, the address 47 is automatically added in each packet, in particular by the program 25 which is activated by the button 13. Furthermore, the packets contain a complementary area 48 indicating the packet number M+i, which enables the circuit 26 of the base transceiver station, and even the server 16, to restore their correct order. In the downlink direction, the mobile telephone 1 sends the server 16 an acquittal.

Given the problems of the GPRS mobile broadcast channel, a packet that is sent is not necessarily received. An improvement to the invention has the server 16, or rather (and preferably) the circuit 26, send to the mobile telephone 1 (in practice to all mobile telephones in its radio coverage area) an acquittal message 49 including an acquittal area 50 designating the number or numbers of the packets received and an address area 51 designating which of the mobile telephones 1 or 45 is to be informed of correct reception of the packet or packets sent. If not received in time, the program 25 can cause a packet M that has not been received to be sent again.

FIG. 4 shows the definition of the uplink GPRS channel between the mobile telephone 1 and the base transceiver station 17. The same type of packet mode transmission is used in the downlink direction, in particular for transmitting the first recognition signal. However, the number of downlink packets can be smaller.

Finally, the presence of a table 51 in the server 16, whose equivalent is contained in the memory 9 of the mobile telephone 1, enables phonetic or other coding of recognition signals so that the memory in area 23 corresponds to a phonetic code which is more than adequate for looking up data in the area 23 and reduces the number of bits that has to be sent. For example, if a code made up of 256 phonemes is adopted, each phoneme is coded on one byte. In this case, because it is possible to send 141 payload bits in a single time slot TSi, it is possible to send up to 16 phonemes in a single time slot to represent a name. This coding mode is one of the compression modes that can be used in the downlink direction.

Depending on the distributed recognition architecture adopted, there is also provision for the user to select an additional option on the keypad of the mobile telephone to constitute the memory 9. In an application corresponding to this additional option, after speaking the name of a party, the user enters the telephone number of that party on the keypad. That number is then stored in area 21 and its recognized equivalent is stored in area 23, after GPRS transmission and return from the server 16 and/or transmission to the server 16. Alternatively, the memory 9 is in the server 16 which returns in the return packet the number to be called, in order for the mobile telephone 1 to execute steps 41 through 44 using that number.

1. A calling method for mobile telephones, wherein:
speech information representing, for example, the name of a party to be called or a command to be executed is spoken into an acoustic sensor of a mobile telephone,
a first digitized speech signal corresponding to said speech information is transmitted to a server,
the server contributes to recognition of said speech information and produces a first recognition signal,
the server transmits said first recognition signal to the mobile telephone, and
the mobile telephone interprets the first recognition signal and correspondingly dials a telephone number corresponding to the party to be called or executes the command to be executed,
in which method the first digitized speech signal or the first recognition signal is transmitted in a packet transmission mode.

2. A method according to claim 1, wherein the first digitized speech signal or the first recognition signal is transmitted in a connectionless packet transmission mode.

3. A method according to claim 1, wherein the first digitized speech signal and/or the first recognition signal is transmitted in accordance with the GPRS standard.

4. A method according to claim 1, wherein the server sends an acquittal signal to the mobile telephone on receiving the first digitized speech signal.

5. A method according to claim 1, wherein the mobile telephone sends an acquittal signal to the server on receiving the first recognition signal.

6. A method according to claim 1, wherein the server recognizes the first speech signal which is distributed and the first speech signal or the first recognition signal is recognized in the mobile telephone.

7. A mobile telephone including an acoustic sensor into which speech information representing, for example, the name of a party to be called or a command to be executed is spoken, means for transmitting to a server a first digitized speech signal corresponding to said speech information, means for interpreting a first recognition signal produced in return by said server and corresponding to said first digitized speech signal, means for automatically dialing a telephone number corresponding to a party to be called or for executing a command to be executed, and means for transmitting the first digitized speech signal in a packet transmission mode.

8. A telephone according to claim 7, wherein the packet transmission mode is a GPRS mode.

9. A server provided with means for receiving a first digitized speech signal, for recognizing speech information in corresponding relationship to said first digitized speech signal, producing a first recognition signal, and transmitting said first recognition signal to a mobile telephone, the server including means for transmitting said first recognition signal to the mobile telephone in a packet transmission mode.

10. A server according to claim 9, wherein the packet transmission mode is a GPRS mode.
